(19) United States
(12) Patent Application Publication
(10) Pub. No.: US 2026/0264429 A1
(43) Pub. Date: Sep. 10, 2026

(54) A PRINTING APPARATUS

(71) Applicant: Dover Europe Sàrl, Vernier (CH)

(72) Inventors: Mohammed Toudmeri, Nottingham (GB); Biser Ivanov, Nottingham (GB)

(21) Appl. No.: 19/128,155

(22) PCT Filed: Nov. 8, 2023
(86) PCT No.: PCT/EP2023/081204

§ 371 Date: May 7, 2025

(30) Foreign Application Priority Data
Nov. 8, 2022 (GB) 2216626.8

(51) Int. Cl. B41J 25/312; B41J 2/33; B41J 2/335; B41J 2/355; B41J 2/375; B41J 29/46

(52) U.S. Cl. CPC B41J 25/312; B41J 2/33; B41J 2/33505; B41J 2/3553; B41J 2/3558; B41J 2/375; B41J 29/46; B41J 2202/31

(57) ABSTRACT

A printing apparatus for transfer printing in which a print head is moved towards and away from an inked tape and a substrate, including: a print head, and a print head actuation assembly and a controller which is configured to control the print head actuation assembly to move the print head between a first rest position, a second ready position and a third printing position, wherein the print head actuation assembly includes: a first solenoid which is connected to the print head to actuate movement of the print head between the first rest position and the second ready position, and a second solenoid which is connected to the print head to actuate movement of the print head between the second ready position and the third printing position.

### FIELD

The present invention relates to improvements to a printing apparatus and methods of controlling a printing apparatus. In particular, the invention can be applied to thermal transfer over-printers (TTO).

### BACKGROUND

In the field of thermal transfer printing, a reel of inked ribbon (also called ‘tape’) is typically mounted onto a spool support. The spool support is rotatable to transfer tape from the first (supply) spool to a second (take up) spool into which tape may be wound after/during use. The second spool support is also rotatable. Various methods of operation of such a reel to reel tape drive are known in the art. Tape is typically transferrable between the pair of spools in both directions, but generally speaking, as ink is removed from the tape during successive printing operations, the used tape is wound onto the second “take-up” spool, such that the diameter of the supply spool decreases and the diameter of the take-up spool increases.

A print head is provided which includes multiple heating elements. As the inked ribbon is moved through the printing apparatus (between the spool supports), it is passed under the print head (and the heating elements). The inked ribbon is sandwiched between the print head and a substrate on which an image is to be printed. One or more heating elements are heated to melt a portion of ink on the ribbon and it is transferred to the substrate to print.

Typically, a pneumatic actuator has been used to move the print head between its deployed printing position, and its retracted position.

Apart from the infrastructure requirement to deliver compressed air, various studies have shown that efficiency of compressed air systems is in the range of 10% to 15%. Consequently, compressed air actuators are deemed to be more expensive to run in comparison with electrical ones. While there is a high demand for cost-effective actuators, the compressed air solution restricts the TTO market to those factories having compressed air facilities.

Embodiments relating to the present disclosure seek to alleviate one or more of the problems associated with known systems.

### BRIEF DESCRIPTION OF THE INVENTION

According to a first aspect of the invention we provide a printing apparatus, for transfer printing in which a print head is moved towards and away from an inked tape and a substrate, including:
a print head, and a print head actuation assembly, and
a controller which is operable to control the print head actuation assembly to move the print head between a first rest position, a second ready position and a third printing position, wherein
the print head actuation assembly includes:
   a first solenoid which is connected to the print head to actuate movement of the print head between the first rest position and the second ready position, and
   a second solenoid which is connected to the print head to actuate movement of the print head between the second ready position and the third printing position.

The first solenoid may be bistable. When the first solenoid is in a first state, the print head may be positioned in the first rest position. When the first solenoid is in a second state, the print head may be positioned in the second ready position. The first solenoid nay be a latching solenoid.

The controller may be operable to supply a signal to actuate the first solenoid between its first and second states. When the signal is removed the first solenoid may remain in the one of the first and second states that it was in when the supply was removed.

The print head actuation assembly may include a third solenoid. The third solenoid may operate in cooperation with the first solenoid. The first and third solenoid may have matching first and second states.

The second solenoid may move the print head between the second ready position and the third printing position using angular rotation. The second solenoid may be a rotary solenoid. The second solenoid may be operable to rotate up to around +60 degrees. The second solenoid may be operable to rotate up to around +45 degrees. The second solenoid may be operable to rotate up to around +30 degrees. The second solenoid may be operable to rotate up to at least around +22.5 degrees. The second solenoid may include an arm. The arm may be connected directly to the print head.

The print head and print head actuation assembly may be provided on a carriage assembly. The carriage assembly may be moveably mounted such that when the first solenoid is actuated the carriage assembly is moved.

The distance between the first rest position and the second ready position may be around 7 mm. The distance between the second ready position and the third printing position may be around 4 mm.

According to a second aspect of the invention we provide a printing apparatus, for transfer printing in which a print head is moved towards and away from an inked tape and a substrate, including
a print head, and an actuator, and
a controller which is operable to control the movement of the print head via the actuator through a control circuit, the controller is operable to:
apply a first supply signal to the actuator, so that the print head is moved to a printing state,
determine a current within the control circuit,
determine, based on the current, a resistance parameter related to a resistance within the actuator,
determine, using the resistance parameter, an updated supply signal for maintaining the print head in the printing state, and
apply the updated supply signal to the actuator.

The controller may be operable to set the first supply signal based on a target current which moves the print head to the printing state. The controller may be operable to determine the updated supply signal using the target current and the resistance parameter.

The controller may, when determining the updated supply signal:
obtain, from a memory, a predetermined constant component resistance which is an aggregate resistance arising from all the components in the control circuit excluding the actuator,
determine a difference between the resistance parameter and the predetermined constant component resistance to establish the resistance in the actuator, and
calculate the updated supply signal using the resistance in the actuator and the target current.

The printing state may include a predetermined print head position and a predetermined pressure that the print head exerts on an inked tape and/or substrate in a printing operation.

The controller may be further operable to:
determine, based on a second current, an updated resistance parameter,
determine, using the updated resistance parameter, a further updated supply signal for maintaining the print head in the printing state, and
apply the further updated supply signal to the actuator.

The control circuit may include a sense resistor. The updated supply signal and/or the further updated supply signal may be higher than the first supply signal. The controller may be operable to: calculate a current temperature in the actuator based on the resistance parameter.

The controller may be operable to provide an alert if the current temperature is higher than a predetermined threshold. The controller may be operable to stop the printing apparatus if the current temperature is higher than a predetermined threshold.

The controller may be operable to decrease the supply signal or the updated supply signal to the actuator if a pause in printing operations is detected. Thus, the controller may be operable reduce the supply signal so that a pressure that is exerted by the print head in the printing state is reduced. The pressure may be reduced to a point at which the print head remains in contact with the substrate and/or inked tape but no significant pressure is applied.

The controller may be operable to increase the supply signal to the actuator when a printing operation is detected.

According to a third aspect of the invention we provide a printing apparatus, for transfer printing in which a print head is moved towards and away from an inked tape and a substrate, including:
a print head, and an actuator, and
a controller which is operable to control the movement of the print head via the actuator through a control circuit, the controller being configured during an initial calibration step to determine a solenoid factor by:
   at a first temperature, determining a current in the control circuit, and
   determining, based on the current, a resistance parameter relating to a resistance in the actuator at the first temperature and using the resistance parameter to calculate the solenoid factor; and
   storing the solenoid factor;
wherein during operation of the printing apparatus the controller is operable to determine a present temperature in the actuator by:
   determining a second current in the control circuit;
   determining, based on the second current, a second resistance parameter relating to the resistance in the actuator, and
   determining, using the second resistance parameter and the solenoid factor, the present temperature in the actuator.

The print apparatus may include a temperature sensor which measures the first temperature. The control circuit may include a sense resistor.

### Using the Resistance Parameter May Include:

obtaining, from a memory, a predetermined constant component resistance which is an aggregate resistance arising from all the components in the control circuit excluding the actuator, determining a difference between the resistance parameter and the predetermined constant component resistance to establish the resistance in the actuator and using the resistance in the actuator to calculate the solenoid factor and/or the present temperature in the actuator.

It should be appreciated that any one or more of the features outlined with respect to the second aspect of the invention may be combined with one or more of the features outlined with respect to the third aspect of the invention. Further, the printing apparatus of the first aspect of the invention could include one or more of the features outlined with respect of the printing apparatus and controller of the second and third aspects of the invention.

Further, according to any of the first and/or second and/or third aspects, we provide a method of operating a printing apparatus in which the controller performs one of the more of the features outlined in respect of the first and/or second and/or third aspects of the invention.

### BRIEF DESCRIPTION OF THE FIGURES

In order that the present disclosure may be more readily understood, preferable embodiments thereof will now be described, by way of example only, with reference to the accompanying drawings, in which:

FIG. 1 illustrates a printing apparatus;

FIGS. 2a, 2b, and 2c illustrate a print head of a printing apparatus in different positions;

FIG. 3 illustrates a print head and print head actuation assembly;

FIG. 4 illustrates a print head and print head actuation assembly;

FIG. 5 illustrates another print head and print head actuation assembly;

FIG. 6 illustrates a print head and print head actuation assembly;

FIG. 7 illustrates an example control circuit for an actuator;

FIG. 8 illustrates an example printing apparatus; and

FIG. 9 illustrates current through an actuator over time.

FIGS. 10 and 11 are graphs illustrating the correlation between Load Cell real measurements and the calculated Back-EMF;

FIG. 32 illustrate the calculation of Rs and it during Stage 1 of Back-EMF calculation;

FIGS. 13 to 17 provide graphs relating to Back EMF calculations; and

FIGS. 18 to 21 relate to methods of establishing the top dead centre position of a roller using methods of embodiments of the technology.

### DETAILED DESCRIPTION OF THE DISCLOSURE

We provide methods of controlling a printer as described herein, and a printing apparatus configured to operate in accordance with one or more aspects of the methods described.

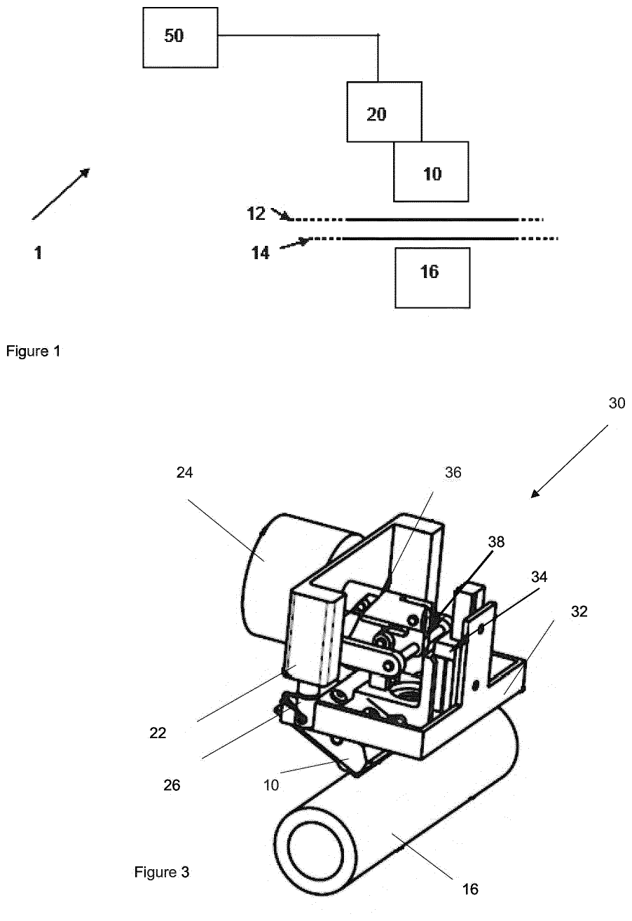

In embodiments, (see, for example, FIG. 1) a printing apparatus 1 is provided. The printing apparatus 1 is used in transfer printing in which a print head 10 is moved towards and away from an inked tape 12 and a substrate 14. Typically, both the inked tape 12 and the substrate 14 is moved past the print head 10 at a desired speed during a printing operation. In the illustrated example, a platen or roller 16 is shown, which is positioned under the print head 10 and provides a surface upon which the inked tape 12 and substrate 14 are pushed against during printing. The print head 10 includes an array of selectively heatable elements (not shown), which are heated to melt ink from the inked ribbon 12 and transfer it to the substrate 14 to form a desired image.

The printing apparatus 1 includes the print head 10, a print head actuation assembly 20, and a controller 50. The print head actuation assembly 20 is coupled to the print head 10 to apply/provide movement to the print head 10 in order to perform printing operations. The controller 50 is operable to control the print head actuation assembly 20-thus, the controller 50 is operable to operate the print head actuation assembly 20, which in turn moves the print head 10 in a desired manner.

Essentially, the controller 50 controls the print head actuation assembly 20 to move the print head 10 between a first rest position, a second ready position and a third printing position.

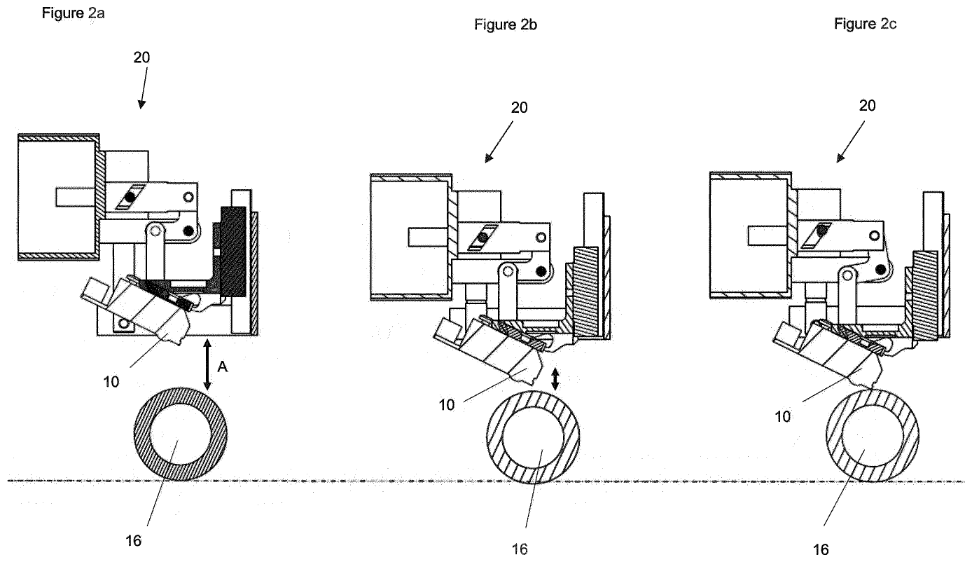

The first rest position is illustrated in FIG. 2a—the rest position is where the print head 10 is completely retracted from the inked tape 12 and substrate 14. The print head 10 is “parked” in a position away from the tape 12, substrate 14, and roller 16, so that the printing apparatus can be taken apart in order to replace consumables (e.g. the inked tape can be replaced with fresh tape when the ink has been used, etc.).

The second ready position is illustrated in FIG. 2b—the ready position is where the print head 10 is lowered to a position that is prepared to start printing. The print head 10 is “primed” in a position lowered from the rest position (i.e. the print head 10 is moved towards the roller 16). In some embodiments, the distance between the rest position and the ready position is around 7 mm (though, it should be appreciated that it could be more or less that 7 mm).

The third printing position is illustrated in FIG. 2c—the printing position is where the print head 10 is held in a position that is appropriate to print (i.e. transfer ink from the tape 12 to the substrate 14). The “print” position is a combination of the print head 10 being in the correct position for printing and exerting an appropriate pressure on the surface (i.e. against the roller 16) that allows printing to occur. The print head 10 is lowered from the ready position (i.e. moved towards the roller 16- and tape 12 and substrate 14). In some embodiments, the distance between the ready position and the printing position is around 4 mm (although, it should be appreciated it could be more or less than 4 mm).

The print head actuation assembly 20 includes a first solenoid 22 and a second solenoid 24. The first solenoid 22 is connected to the print head 10 to actuate movement of the print head 10 between the first rest position and the second ready position. The second solenoid 24 is connected to the print head 10 to actuate movement of the print head 10 between the second ready position and the third printing position.

In other words, each of the first and second solenoids 22, 24 is coupled to the print head 10 in order to actuate different movements of the print head 10. The first solenoid 22 is configured only to be able to provide the movement of the print head 10 between the first rest position and the second ready position (i.e. the first solenoid 22 is not actuated for any other type of movement and cannot control the position of the print head 10 past the ready position. In other words, the first solenoid 22 is not capable of any movement except the first to second position and vice versa. The second solenoid 24 is configured only to be able to provide the movement of the print head 10 between the second ready position and the third printing position (i.e. the second solenoid 24 is not actuated for any other type of movement and cannot control the position of the print head 10 upwards past the ready position). In other words, the second solenoid 24 is not capable of any movement except from the ready position to the printing position and vice versa.

Thus, the movement of the print head 10 is controlled by two separate solenoids 22, 24.

In some embodiments, the first solenoid 22 is a bistable device (i.e. the solenoid has two stable states). In the present example, the first solenoid 22 has a first state in which the print head 10 is positioned in the first rest position. The first solenoid has a second state in which the print head 10 is positioned in the second ready position.

Further, in some embodiments, the first solenoid 22 will remain in which ever state it even if the power signal is removed. Thus, a supply signal can be provided which switches the first solenoid between positions (i.e. into the first rest position or into the second ready position) and when the power is removed, the first solenoid 22 will remain in the state it was switched to when the power was on. In other words, the controller 50 is operable to supply a signal to actuate the first solenoid 22 between its first and second states. Further, when the signal is removed (i.e. the controller 50 powers off the signal) the first solenoid 22 remains in the one of the first and second states (e.g. the rest position or the ready position) that it was in when the supply was removed.

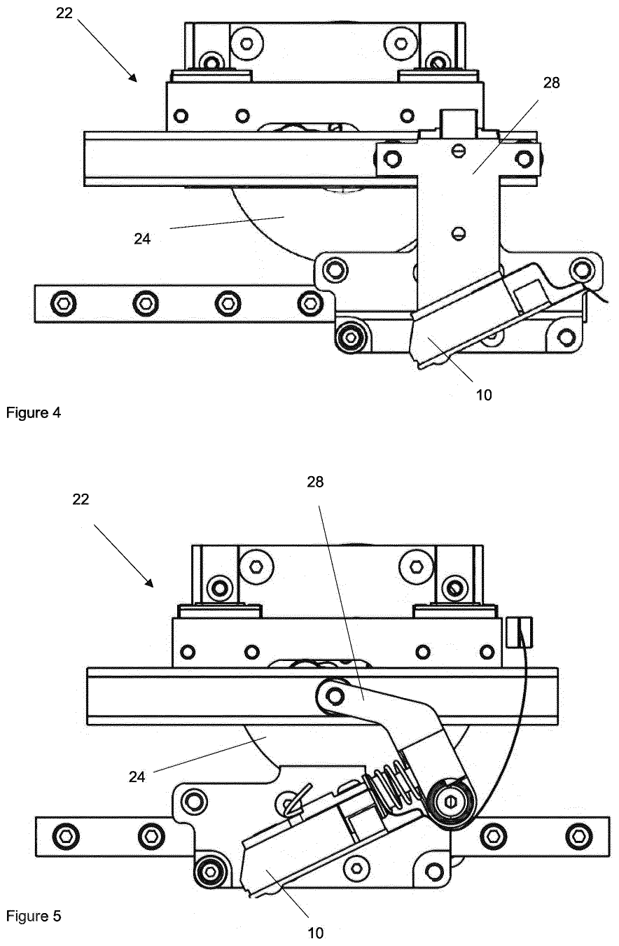

In some embodiments, the print head actuation assembly 20 includes a third solenoid 26 (see FIG. 3). In this example, the third solenoid 26 operates in cooperation with the first solenoid 22. In other words, the third solenoid 26 also controls/provides movement of the print head 10 between the first rest position and the second ready position. Essentially, the first and third solenoid 22, 26 have matching first and second states. The controller 50 is operable to provide an actuation signal to both the first and third solenoids 22, 26 to move the print head 10 to the first rest position, or the second ready position.

In the present example, both the first and third solenoid 22, 26 are bistable solenoids that will remain in a set/stable position when a power signal is removed. Thus, both solenoids 22, 26 work together to ensure the print head 10 is moved as desired.

In some embodiments, the second solenoid 24 moves the print head 10 between the second ready position and the third printing position using angular rotation. In some embodiments, the second solenoid 24 is operable to rotate up to at least 45 degrees—i.e. the second solenoid 24 is capable of moving at least 22.5 degrees either side of a central position.

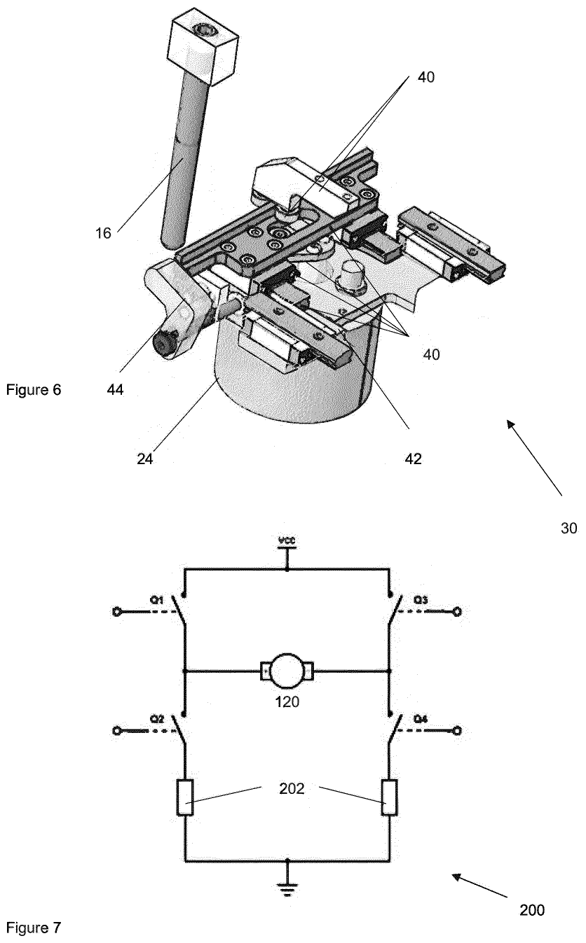

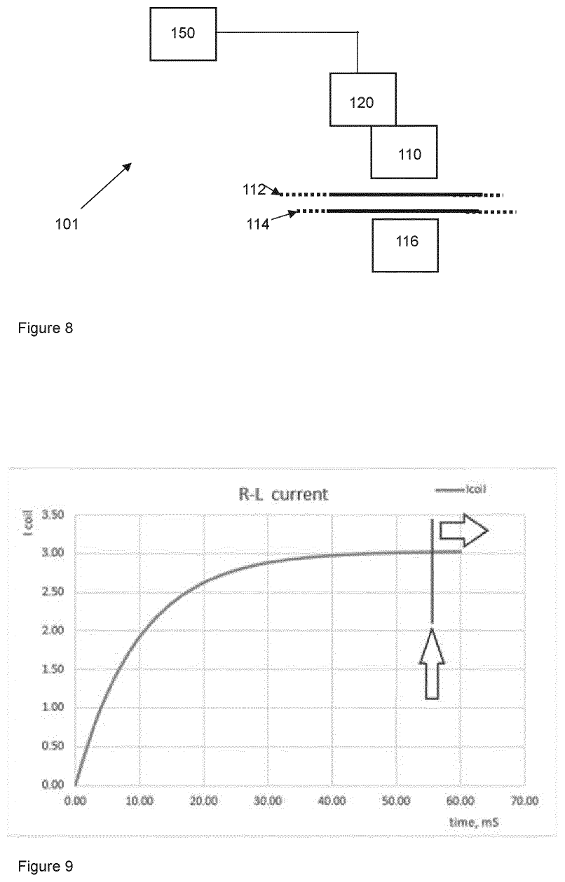

In some embodiments, the second solenoid 24 includes an arm 28 (see also FIGS. 4 and 5). The arm 28 may be connected directly to the print head 10 and, thus, when the second solenoid 24 is actuated the arm 28 moves angularly and the print head 10 is pivoted downwards or upwards (depending on the supply signal—i.e. which direction the second solenoid 24 is being moved in).

As can be seen in FIGS. 3, 4 and 5, the print head 10 and print head actuation assembly 20 are provided on a single carriage assembly 30. In other words, the entire carriage assembly is mounted moveably in the printing apparatus 1. The first (and, if present, the third) solenoid 22, 26 push the entire carriage assembly 30 downwards/towards the roller 16. The second solenoid 24 operates to push the print head 10 through an angle towards its printing position. Details of the carriage assembly 30 are discussed further below.

In some embodiments, the first solenoid 22 and/or the third solenoid 26 is a latching solenoid. The second solenoid 24 is a rotary solenoid. In the illustrated embodiment, a combination of rotary and latching solenoid is used as shown in FIG. 3. As discussed above, the mechanism to designed to move the printhead between three positions as illustrated in FIGS. 2a-2c: 1) Parking position (i.e. the first rest position), 2) Priming position (i.e. the second ready position), 3) Printing position (i.e. the third printing position).

In some embodiments, the print head actuation assembly 20 incorporates two magnetically latching solenoids 22, 26 to toggle between the Park and the Prime positions (i.e. the first and second positions). Further, a rotary solenoid 24 is used to further move between the Prime and the Print position (i.e. between the second and third positions). In some embodiments, the three devices are incorporated in one unit called a tri-solenoid print head module (also called the print head actuation assembly 20).

FIG. 3 illustrates portions of the print head actuation assembly 20. In the illustrated example, a static frame 32 is fastened rigidly to the body of the printer (i.e. provides the main support for the carriage assembly 30 within a housing of the printing apparatus 1). Other components are attached to the static frame 32 via a linear slide 34.

In this example of a printing apparatus 1, the main housing of the apparatus is provided in two parts—a main body part and a cassette part that is removable (e.g. to replace the consumables). When the cassette is inserted into the main body the two priming solenoids (i.e. the first and third solenoids 22, 26) are energised and the print head 10 moves from the park (i.e. the first position) to the prime position (i.e. the ready position).

The carriage assembly 30 is moved to the second ready position (as illustrated in FIG. 2b). In other words, the tri-solenoid assembly (the print head actuation assembly 20), a helical spigot 36, a linkage cam 38 and print head 10 move to the prime position, as shown in FIG. 2b. When the prime position (i.e. the second ready position) is established the current to the prime solenoids (i.e. the first and third solenoid 22, 26) is cut. The mechanism/carriage assembly 30 stays in place by solenoid latching magnets within the tri-solenoid assembly/print head actuation assembly 20. This reduces power consumption and heat build-up within the Tri-solenoid body (i.e. within the body of the solenoids and particularly within the first solenoid 22 (and third solenoid 26 if present)).

When a print signal is received by the rotary print solenoid (i.e. the second solenoid 24), the second solenoid 24 is energised causing the second solenoid's 24 shaft to rotate. In this example, the shaft includes a pin located in the shaft, which acts on a helical slot in the helical spigot 36.

This causes a linear motion to the left (as shown in FIG. 2c). This in turn applies a force to the linkage cam 38 thus pushing the print head 10 down to the print position.

In the third printing position, the print head 10 can now be energised melting the ink where appropriate which transfers to the packaging material producing the required image.

When the image is complete, the current to the rotary print solenoid 24 is reversed which has the action of rapidly returning the print head 10 to the prime position. The current to the prime solenoids 22, 24 is not applied to reduce power consumption. The mechanism will sit in the prime position awaiting the next print signal.

When the cassette needs to be removed to replace a used ribbon 12 the two prime solenoids 22, 26 are energised in the reverse direction, this has the effect of breaking the magnetic attraction of the prime solenoids 22, 26 and the mechanism will return to the park position to aid cassette removal.

In embodiments, the selected rotary solenoid 24 for this exercise travels up to an angle in a range of +60°, preferably in a range of +45°, more preferably around +30°, and more preferably still+22.5° angle.

The minimum travelling distance of the print head 10 in the print head 10 actuation direction (indicated by arrow A in FIG. 2a) may be 5 mm or more; for example, it may be 11 mm. In other words, the print head 10 must be able to move between the first rest position and the third printing position by some means (i.e. in order to print, a mechanism must provide at least movement between parked and printing positions).

In the present example, to achieve movement between the first and third positions (i.e. this travel of 11 mm), where the print head 10 mechanism is connected directly to the end of the arm 28 of a rotary solenoid 24-which is shown in FIG. 4, a minimum arm length of 16 mm is needed. Further, a rotation angle of 40° is required.

During printing, the print head 10 typically needs to exert at least 15-20N of force, and preferably around 27N against the platen/roller 16. In this example, this force, using the distances above equates to ~0.46 N.m solenoid torque. This torque is very close to the extreme limit of the power that can be applied to the second solenoid 24 (i.e. it is close to the extreme for the selected solenoid 24 at 100% duty cycle in terms of the PWM signal).

FIG. 5 shows another embodiment in which the print head 10 is connected to the second solenoid 24 via a shorter arm 28. This configuration achieves the minimum stroke length with shorter arm and 40° rotation. This method uses the lever's principle. However, the required solenoid 24 torque would remain high.

To reduce the torque, the print head travel is divided into two stages. As discussed above, the distanced to reach each stage is:
i. Park to Prime (~7 mm)
ii Prime to Print (~4 mm)

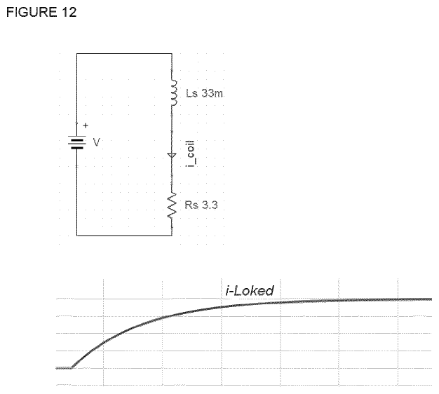

Further details of the carriage assembly 30 are shown in FIG. 6. In a first stage, the rotary solenoid 24 and associated print head linkages 40 are mounted on a plate 42. The plate 42 slides in parallel to a main plate of the printer (chassis). The linkages 40 are provided in order to connect the print head 10 to the solenoids 22, 24 and allow the print head 10 and the overall carriage assembly 30 to move as desired.

In some embodiments, the plate 42 provides the movement from the parking position to the prime position. In this example, this movement is achieved by pushing the lever 44 by a screw mounted on the cassette.

It should be appreciated, that this movement can be achieved in many other different forms such as using wedge or other linkages. The use of a static wedge would reduce the power and associated heat generated.

Splitting the movement of the print head 10 between two different solenoids 22, 24 in the print head actuation assembly 20 allows the power consumption and heat accumulation to be reduced from a single solenoid solution. The first solenoid 22 handles the movement of the print head 10 from the rest position to the ready position and can be switched off once the movement is complete-due to the bistable nature of the first solenoid 22 it will remain in position even once the power is removed.

Thus, there is minimal build-up of heat in the first solenoid because once the movement operation is complete it is effectively switched off.

The remainder of the movement of the print head 10 is handled by the second solenoid 24. However, due to the fact that the first solenoid 22 has already moved the print head 10 to the ready position, the second solenoid 24 does not need to provide such a long range of movement. In this way, the stroke/movement performed by the rotary solenoid 24 is reduced from 11 mm to 4 mm. The arm length can be reduced and consequently the torque (T) required to provide the same print head pressure is reduced by a ratio:

$${T}_{2} = {T}_{1} \frac{{R}_{2}}{{R}_{1}} .$$

Where R₁ and R₂ in this example provide the distances that a solenoid would be required to provide print head movement through, and the T₁ and T₂ is the torque in the same scenario. In other words, in a system where one solenoid provides the entire print head movement from the rest position to the printing position, this distance is R₁—i.e. around 11 mm (the torque required to provide that is T₁). Whereas, in the present system the second solenoid 24 is only required to control movement of the print head 10 between the ready position and the printing position, which is R₂—i.e. around 4 mm (the torque required to provide that is T₂). The rearrangement below illustrates that the second scenario discussed above (i.e. with split print head 10 movement) requires approaching 3 times less torque.

$$\frac{{T}_{2}}{{T}_{1}} = \frac{{R}_{2}}{{R}_{1}} \approx 3$$

Thus, the size of the solenoid 24 required can be reduced. The power and heat generated will also be decreased. Cost of ownership is reduced, and printers can cope with higher environmental temperature.

Further, in embodiments, a return spring is no longer required as it would be in a single solenoid system. A return spring pulls the printhead back to its rest position when the current is removed from the solenoid. By relying on return spring, the power used to operate the solenoid and to apply pressure at the end of the stroke it needs to accommodate the extra forces generated by the return spring. In addition, the retraction of the print head tends to be slow as we rely solely on the spring. The design of the spring rate is a fine balance between the power required to activate the print head and the spring rate under which the speed of the print head retraction is controlled.

The rotary solenoid is introduced to eliminate the need for an external returning/retraction spring. It uses the reverse current to perform the print head retraction. The larger the current the faster is the retraction. The rotary solenoid chosen works in a range between +22.5° with a return to a neutral position at 0°. The torque curves of the solenoid show that the torque at it is highest close to 0° and consistent between −15° to 5°.

### Use of Back EMF to Control and Improve Printing Quality

When the arm of the rotary solenoid moves through the magnetic field, an Electro Motive Force is induced in the coils. This is called the Back-Electro Motive Force (Back-EMF), which is a voltage that is opposite to the applied voltage.

The Back-EMF can therefore be used to detect movement. When the solenoid pushes the print head down to the print surface, a Back-EMF is generated. This disappears when the print head reaches and stabilises on the print surface.

The Back-EMF is proportional to the angular velocity of the rotary solenoid's arm. By integrating the Back-EMF (i.e. the area of the curve when plotted as a graph), we determine travel distance.

This method is based on measuring the current of solenoid only. The actual Back-EMF cannot be measured directly, its hidden inside solenoid windings, therefore a method of its calculation is needed.

Two stages are needed; we drive the solenoid with constant average voltage V_{avg}=Vₚₛᵤ PWM where Vₚₛᵤ is the power supply voltage.

### Stage 1

We measure the current of locked solenoid from 0 to steady state condition (we calculate the inductance Ls and Rs in this step, which is required for stage 2). This first step needs to be done once at system initialisation for Ls calculation and every print cycle for Rs calculation.

We need the solenoid to be locked i.e. not free to move, which is achieved in the test printer by moving the head in the UP direction at system initialisation. Because there is a stopper the print head cannot move more and the solenoid is assumed to be “locked”.

In this condition the current follows the theory for L-R circuit as shown in FIG. 12.
a) Calculating Rs (discussed in more detail below and illustrated in FIG. 35)
b) Calculating Ls

We choose a point where the current is between 40% to 60% of the maximum current at steady state, at this point we have iₜ and t₁ (see FIG. 13). We already know the voltage V_{avg} and Rs, so we rearrange the formula:

$${i}_{t} = \frac{{V}_{avg}}{{R}_{s}} ( 1 - {e}^{- \frac{t}{τ}} ) , τ = \frac{{L}_{s}}{{R}_{s}}$$

and work out the inductance:

$${L}_{s} = \frac{t {R}_{s}}{ln ( \frac{{V}_{a v g}}{{V}_{avg} - {i}_{t} {R}_{s}} )}$$

where: t=t₁-t0

Note: the time 0 and the point in time where we calculate the inductance must be absolute and the filtering effect/delay introduced by filter could introduce errors in the above formula and must be taken into account when we calculate the time t. If voltage and current have filter attached (digital or hardware) both filters must behave the same way i.e. same cut off and de/oct slope, otherwise the calculations may be prone to errors due to artefacts in the signal.

Calculated series inductance Ls at this step can be stored in memory (EEPROM). If the solenoid is replaced this step must be executed again. Alternately step 1 can be executed at system initialisation to measure the inductance Ls rather than storing it.

Calculated series resistance Rs is temperature dependant and must be measured every print cycle. This is used in Stage 2, described below.

### Stage 2

At stage two of the process, we measure the current of the free (rotating) solenoid from 0 to its steady state condition, using the calculated Ls and Rs values from step 1, we extract the Back-EMF from the solenoid current.

The solenoid must be “free to move”, and this is achieved in the printer by moving the head in the DOWN direction (i.e., printing). While the print head travels towards the substrate, it creates Back-EMF.

In this condition the current follows the theory for a L-R circuit, with the additional element which is the Back-EMF, as illustrated by FIG. 14 of the drawings. Note the difference between the current observed in the “Locked” (“i-loked”) and “Free to move” (“i-free”) states of the solenoid caused by the Back-EMF, as illustrated in FIG. 14.

Performing a transient analysis of the closed loop circuit using Kirchhoff's 2nd Law (i.e., Voltage Law), which states that the sum of all the voltages around a closed loop series path is equal to zero, we determine the following to find the Back-EMF.

$${v}_{t} \text{?} \begin{matrix}v = {emf}_{t} \\ v = {L}_{s} \frac{Δ i}{Δ t} \\ v = {R}_{s} {i}_{t}\end{matrix} \begin{matrix}{emf}_{( t )} + {v}_{L ( t )} + {v}_{R ( t )} + ( - {v}_{( t )} ) = 0 & \to \\ {emf}_{t} = {v}_{t} - ( {R}_{s} {i}_{t} + {L}_{s} \frac{Δ i}{Δ t} ) & \to \\ {emf}_{t} = {v}_{t} - ( {R}_{s} {i}_{t} + {L}_{s} \frac{\text{?}}{T \text{?}} ) & \end{matrix}$$

$$where \text{?}$$

$$\text{?} \text{indicates text missing or illegible when filed}$$

This method has the advantage that it measures all resistances in the solenoid circuit, including Solenoid DC Resistance Rₛ+Rₛₑₙₛₑ+X2. R_{DS}_{_{(ON)}} of MOSFETs+cables resistance etc. and cancelling out the different solenoid samples Ls and Rs variations. This method calculates the Back-EMF in real time independently of solenoid samples which vary according to the specific solenoid and electronics driver that controls it.

We note that Back-EMF is derived by measuring the solenoid current, but the solenoid voltage itself is not measured (since it is known), but subject to the following points:
The solenoid voltage vₜ=VₚₛᵤPWM % varies with the time as PWM varies, and the power supply voltage Vₚₛᵤ is constant eg. 36V, so only PWM % is controlled by the firmware.
The solenoid current iₜ is measured by the microcontroller ADC and because the signal is noisy, an external (and/or software-based) Low-pass filter is applied.

Both voltage vₜ and current iₜ must have same “filtering effect” applied to them, otherwise an artefact will appear in the calculations, which does not exist in the real signal being evaluated.

For example, consider this formula for Back-EMF calculation:

$${emf}_{t} = {v}_{t} - ( {R}_{s} {i}_{t} + {L}_{s} \frac{Δ j}{Δ t} ) ,$$

If the voltage vₜ is 5V and the current iₜ at the time, given by

$$( {R}_{s} {i}_{t} + {L}_{s} \frac{Δ i}{Δ t} ) ,$$

is 5V as well; emfₜ at the time is 5−5=0.

If we apply a Low-pass filter to the current, only, and not to the voltage, this term

$$( {R}_{s} {i}_{t} + {L}_{s} \frac{Δ i}{Δ t} )$$

will not be=5V because of the filter delay effect. For example, if it is 4V at the present time, the calculated Back-EMF emfₜ at that time would be 5−4=1V instead of 0 Volts; this 1V value is an artefact, as it doesn't exist in real signal but is caused by the misapplication of the filtering effect.

These effects and the artefacts created are illustrated in FIG. 16 of the drawings. In that figure a Red trace is real Back-EMF, the Purple trace is the result of the formula used to extract Back-EMF.

All filters have the same magnitude/order for voltage and the current channel, and both Back-EMFs (Red and Purple traces) overlap perfectly.

FIG. 17 provides two graphs showing how the application of different filters for the voltage and the current channel affect the calculation, and both Back-EMFs (the Red and Purple traces) demonstrate artefacts.

It is important to note that if we integrate the Purple Back-EMF trace to determine the distance/gap for the three example cases shown here, we determine different results in each case because of the artefact in the signal. As long as the filter order and cut-off frequency doesn't change, the artefact will be present, but it is consistent between each print head movement. Therefore, although accuracy of the determination is not perfect, this provides sufficient accuracy for us to use Back-EMF to find the top dead centre of the print roller, and to tune the print head position automatically, or detect lack of movement of the print head, for example.

### Calculating the Travel Distance of the Print Head

The Back-EMF is proportional to the angular velocity of the rotary solenoid. By integrating the Back-EMF we determine the print head travel distance i.e., its displacement.

$$Δ x = {\int }_{{t}_{θ}}^{{′}_{1}} v ( t ) dt$$

The above formula is implemented in the firmware like this:

$$D = {D}_{0} + k {\sum }_{t = 0}^{∞} {emf}_{( t )} {T}_{s}$$

where:
D the distance,
Dₒ the initial distance (0 in our case with print head application),
K the Integrator coefficient i.e. scale factor,
Ts sampling time,
emfₜ Back-EMF at sample (t);
∞ This is the time taken for current to get to steady state after which there is no discernible change in current so back-emf is infinitesimal and can be considered zero.

### Detecting Print Head Lack of Movement

By knowing the gap between print head and the substrate, we can detect a lack of movement of the print head by applying a threshold to the control software. For example, assuming the gap at system initialisation (via a calibration process) is found to be 0.8 mm. During subsequent printing, any determined movement below 0.6 mm may generate an error event.

A way to increase the accuracy and detect the print head movement is to compare the shape of the Back-EMF, or its integrated value (i.e., the gap) between the current print and the previous print.

If we calculate the print head gap based on the Back-EMF method as described, this can be determined in units other than mm—the nature of the unit is arbitrary. For example, if the value for the previous print was determined to be 150 units (in arbitrary units—this may correlate to 0.8 mm for example), and the current print is found to be 155 units, we can say that the print head appears to be moving as it should. So, in this way, we may apply a threshold of an allowed 10% divergence between printing operations. If the threshold is breached, this may generate an error event indicating that the print head is not moving as it should. A threshold of 10% may be suitable, or alternatively a threshold of 20% or 30%, for example.

### Detecting the “Top Dead Centre” of a Print Roller by Using Back-EMF

Using the above-described Back-EMF method provides a solution for calculating the gap between the print head and substrate or roller, and thus also allows the top dead centre position of the roller to be determined.

The print head is moved between a far-left side position (indicated at 1 in FIG. 18), and then slowly moves to the other end to the right side (indicated at 2). Each time the print head travels towards the roller, the distance (i.e., the gap) is calculated.

This way a two-dimensional matrix can be created—wherein the X axis is the position of the print head in terms of its “left to right” position and the Y axis is the gap between print head and the roller. See the graph in FIG. 19. The point of minimum Y axis value correlates to the minimum distance—i.e., the corresponding X axis position of the intermittent solenoid where the roller top-dead centre is.

The gap calculation doesn't need to be highly accurate because we are not interested in the specific value. Rather, it is the change of the gap distance measured in relation to print head position, from left to right, that is useful.

The two charts of FIGS. 20 and 21 show the Back-EMF nonlinearity and the roller top dead centre position. If the Back-EMF's curve slope is always positive, and doesn't change to flat or negative, it can be used to achieve very good performance (and be used as an input for control of “smart” printer features for example).

Changing the print head angle can be done at no cost in cases where a print roller is used, and by knowing the top dead centre position of the roller, we can offset the print head from the centre. This way a print angle can be adjusted, in embodiments in which ha print roller (platen) is provided underneath the print head.

It should be appreciated that while the above methods and operation is outlined with reference to a solenoid, a DC-motor could be used instead and the same procedure could be implemented.

### Maintaining Constant Print Head Force/Pressure During Printing

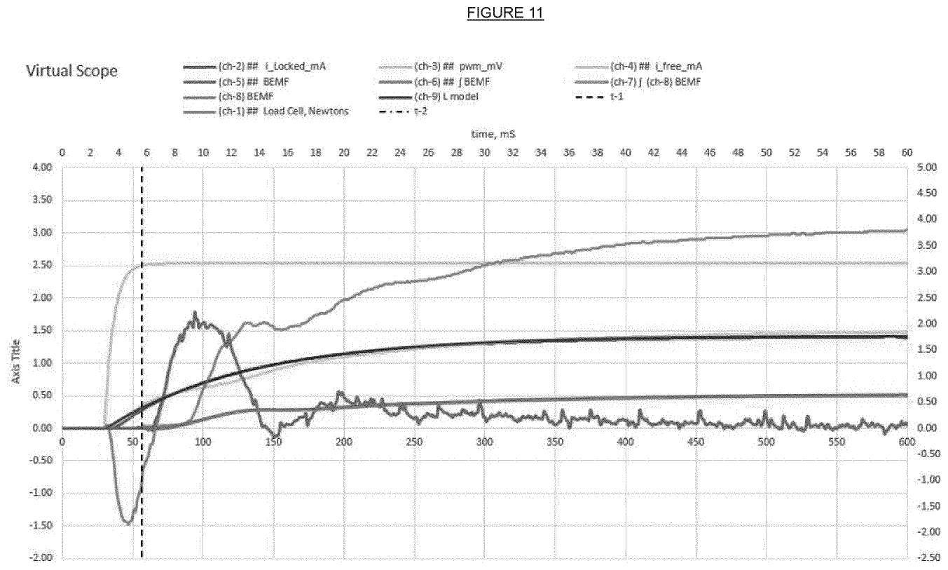

The following description relates to a way in which a controller operates a printing apparatus and the associated method of operation. The controller could implement this operation in relation to the system described above (in relation to FIG. 1) or in another system in which a single actuator is used. FIG. 8 illustrates a more general printing apparatus for the purposes of the operation discussed here-similar features are given the same reference with 100 added (i.e. 1 becomes 101 and 20 becomes 120, etc.).

In some embodiments (see FIG. 8), the printing apparatus 101 includes an actuator 120, a print head 110 and a controller 150. The controller 150 is operable to maintain the print head 110 in the printing position (i.e. the position and pressure in which the print head 110 performs printing operations). In order to maintain the printing position (and importantly the required print head 110 pressure on the roller 116, tape 112, and substrate 114, a constant current must be generated through the actuator 120. Torque generated by the actuator 120 (and applied to the print head 110 to provide the necessary pressure) is proportional to the current through the actuator 120. It should be appreciated that, in this example, the actuator 120 will be a motor (preferably a DC-motor) or a solenoid.

For example, a DC-motor/solenoid 120 torque is proportional to the product of the armature current and the machine's total flux strength. In the case of a permanent-magnet motor, the flux strength can be considered constant in normal working conditions, so the DC-motor torque is linearly proportional to the coil current only:

$$T = {kl}_{a}$$

where T=solenoid/DC motor torque;
Iₐ=current (through the armature of the motor/solenoid); and
k=constant.

Since the solenoid or DC-motor coil resistance will rise with temperature it is difficult to maintain a constant pressure. Keeping a constant supply voltage (with a PWM % signal) is not a good solution to maintain constant current (which in turn controls the torque and the force applied to the substrate 114).

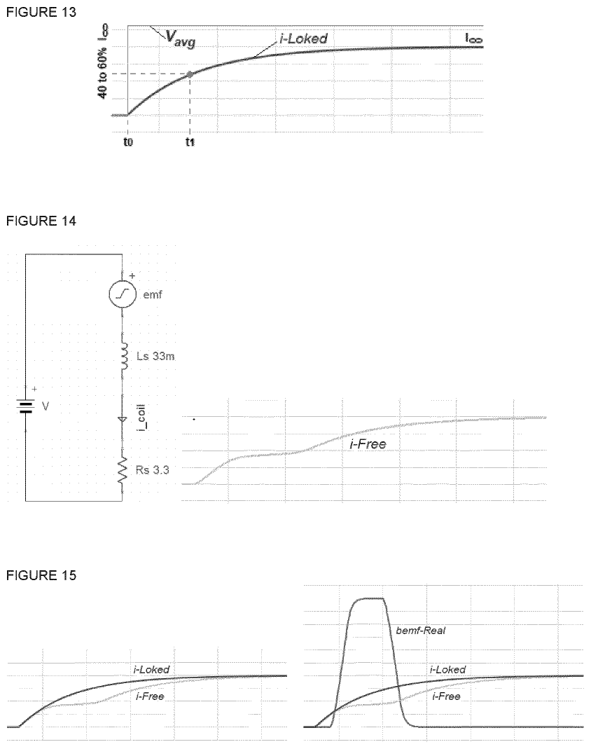

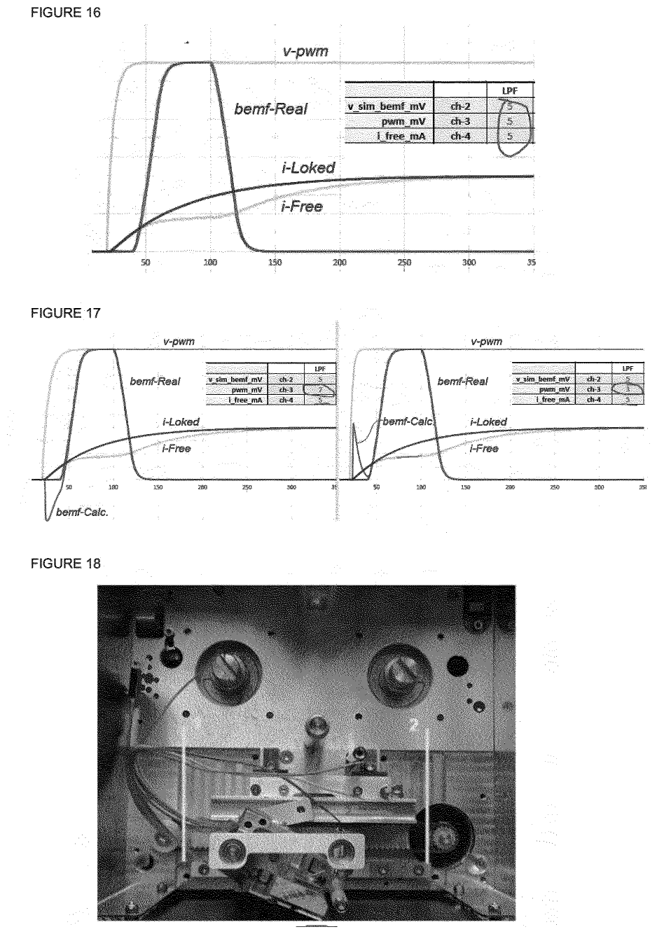

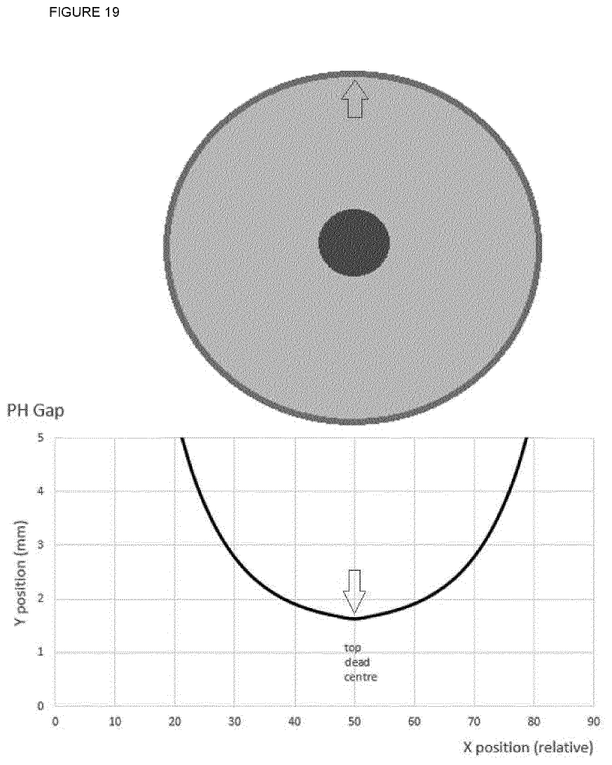

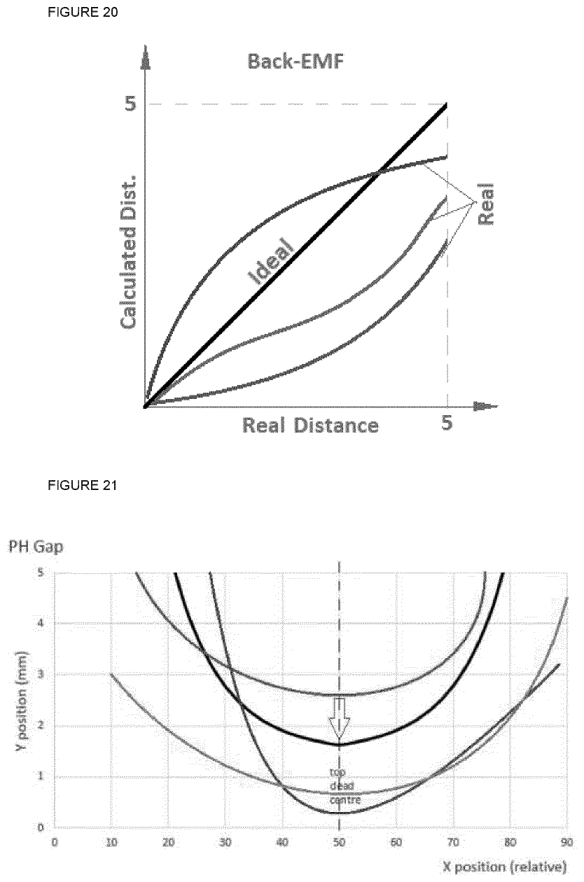

It should be appreciated that by “constant current”, it is meant the average current at steady state and during printing (with no vibration). This is illustrated in FIG. 9—the arrows provide an indication where the current is considered to be at a steady state.

In the present example, the controller 150 is operable to control the movement of the print head 110 via the actuator 120 through a control circuit 200. In order to maintain the print head 110 pressure, the controller 150 is operable to complete the following steps during operation:
1) apply a first supply signal to the actuator 120, so that the print head 110 is moved to a printing state,
2) determine a current within the control circuit 200,
3) determine, based on the current, a resistance parameter related to a resistance within the actuator 120,
4) determine, using the resistance parameter, an updated supply signal for maintaining the print head 110 in the printing state, and
5) apply the updated supply signal to the actuator 120.

For step 1, the controller 150 applies the first supply signal to the actuator 120 which is predetermined to generate the required position and pressure in the print head 110. Essentially, the printing state is the combination of the position and pressure of the print head 110 in relation to the roller 116 (and/or the tape 112 and/or the substrate 114) to perform a printing operation. In other words, the printing state includes a predetermined print head 110 position and a predetermined pressure that the print head 110 exerts on an inked tape 112 and/or substrate 114 and/or the roller 116 in a printing operation.

In some embodiments, the controller 150 has a predetermined initial supply signal that will generate the required current in the actuator 120 (and, thus, the required torque for the print head 110 to exert pressure onto the roller 116). When the solenoid is cool, the current is sufficient to apply the required force to the ribbon 112 and substrate 114. In this example, the controller 150 is operable to set the first supply signal based on a target current which moves the print head 110 to the printing state.

Once the actuator 120 is in use, it will begin to heat. As the actuator 120 heats, its resistance will increase. For example, at 65° C. the current generated drops due to increasing resistance of the actuator 120 windings. This decreased current is then insufficient to maintain the required force between the print head 110 and the substrate 114 (which would result in poor quality printing).

For step 2, the controller 150 is operable to determine the current within the control circuit 200 for the actuator 120. In other words, the controller 150 is able to assess the instantaneous current in the control circuit 200—and, thus, the current through the actuator 120.

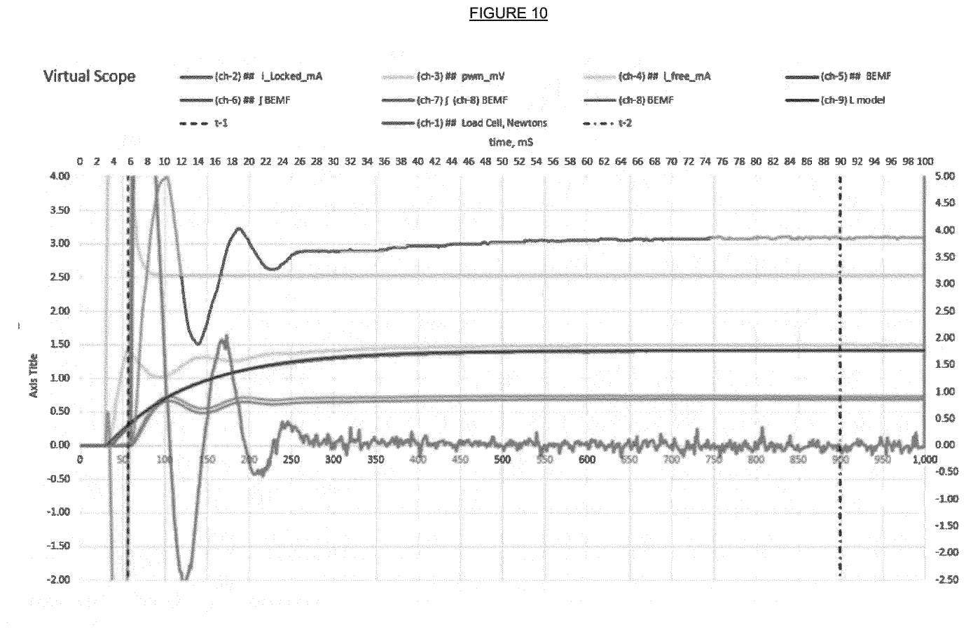

The control circuit 200 (or the important components of the control circuit 200) are illustrated in FIG. 7. In some embodiments, the control circuit 200 includes a sense resistor 202. As can be seen in the example illustrated, two sense resistors 202 are provided.

A sense resistor 202 is placed in series with the control circuit 200 being measured. The voltage across the resistor 202 is then measured. This voltage is proportional to the current flowing through the resistor 202. Since the resistance value of the current sense resistor 202 is known, the current flowing through the circuit 200 can be calculated. The value of the sense resistor 202 is chosen carefully as this determines the voltage drop across it (and, hence the current through it).

Thus, the controller 150 is able to monitor the instantaneous/present current in the control circuit 200.

For step 3, the controller 150 uses the present current within the control circuit 200 (determined in step 2), to determine the resistance parameter (i.e. the total resistance of the control circuit 200 as a whole). Thus, the resistance parameter includes both the resistance within the actuator 120 and the resistance of the other components within the control circuit 200.

For step 4, the controller 150 uses the resistance parameter to determine a new/updated supply signal.

In some embodiments, the resistance parameter is converted to the resistance within the actuator 120. Essentially, the controller 150 stores the resistance of the other components within the control circuit 200. Typically, the other components, will maintain a constant resistance (or close to a constant resistance) irrespectively of how long the control circuit 200 has been in use. Thus, the controller 150 can obtain (from a memory, for example) a predetermined constant component resistance which is an aggregate resistance value arising from the components in the control circuit 200 (excluding the actuator 120).

In some embodiments, the predetermined constant component resistance is determined by the controller 150 at an earlier time (i.e. before the control circuit 200 and the actuator 120 has heated and changed resistance). This may be straight forward since the components in the control circuit 200 are well known.

For example, a sense resistor 202 has a known resistance since this is how they work to provide an indication of the current in the control circuit 200. The control circuit 200 may also include one or more MOSFETs-which also have a low resistance. Lastly, the remainder of the control circuit 200 may have an inherent resistance (e.g. associated with the wires, etc.). Thus, the components of the control circuit 200 are well known and, as such, the resistance of them is also well known.

In some embodiments, the controller 150 then determines a difference between the resistance parameter and the predetermined constant component resistance. This establishes what part of the resistance parameter is the resistance in the actuator 120.

In other words, the controller 150 calculates the present/instantaneous resistance in the actuator 120. It should be appreciated that once the actuator 120 is in operation, the resistance will increase over time.

The updated resistance of the actuator 120 is used alongside the target current to determine the updated supply signal. In other words, as discussed above, the controller 150 has a predetermined target current required to provide the required position and pressure of the print head 110. The target current does not change over time. Thus, once the controller 150 has the updated resistance of the actuator 120 and the target current, the updated supply signal required to bring the current back up to the target current can be determined.

This is through Ohms law where the voltage is equal to the target current multiplied by the updated resistance of the actuator 120.

In the present example, the controller 150 is operable to apply the updated supply signal through the control circuit 200 to the actuator 120. The cycle is iterative, with the controller 120 constantly (or at predetermined intervals) reassessing the instantaneous current (i.e. a second current) in the control circuit 200.

Thus, in some embodiments, the controller 150 establishes an updated resistance parameter, based on the updated (second) current value. Which further allows the controller 150 to determine a further updated supply signal for maintaining the print head 110 in the printing state. Lastly, the further updated supply signal is applied to the actuator 120.

It should be appreciated that the general form of the iteratively updated supply signals will be upwards. As the actuator 120 heats, the resistance increases, always resulting in an increased voltage being required to maintain the target current for the print head 110.

In embodiments, an implementation in software (i.e. how the controller 150 operates) is based on measuring the solenoid/DC-motor coil (i.e. the actuator 120) resistance in real-time. This means that the controller 150 maintains this measurement while printing is occurring and adjusting the applied solenoid voltage (i.e. the updated supply signal). In this way the current may be maintained at the level required for the printing state (which may be a user-defined value or set-point).

The updated supply signals can be determined in a straight forward manner. Further, the controller 150 may be operable to implement a pulse-width modulation (PWM) signal in which the supply signal is provided in pulses. Knowing the current (i.e. the target current) we need in order to drive the actuator 120, and the solenoid coil resistance, the PWM value can be determined (in a 0 to 1 range) using the formula:

$$PWM = \frac{{V}_{avg}}{{V}_{psu}} = \frac{{I}_{sol} {R}_{sol}}{{V}_{psu}}$$

Or, to calculate it within a 0 to 100% range:

$$PWM = 100 \frac{{I}_{sol} {R}_{sol}}{{V}_{psu}}$$

where in all cases:
PWM=is a ratio of the time the signal/voltage is on divided by the total time in the pulse (i.e. time on plus time off)
V_{avg}=the average voltage
Vₚₛᵤ=proper supply voltage (i.e. the supply signal required)
Iₛₒₗ=actuator 120 current (measured by the sense resistor 202 in the control circuit 200)
Rₛₒₗ=actuator 120 resistance (where this is a solenoid or motor, this will be the windings resistance)

Thus, the controller 150 is operable to determine an iteratively updating supply signal for the actuator 120. This supply signal may involve a PWM type signal where the same voltage is applied in select bursts across a pulse—this the length of the bursts can be altered to generate the desired energy across the pulse.

A specific example of how to assess the series resistance of the control circuit 200 and, thus, establish an updated resistance for the actuator is discussed below.

By measuring the solenoid 120 current at steady state and knowing the supply voltage, we can calculate the Series Resistance in the system. In other words, if the current is measured before the actuator 120 has opportunity to rise in temperature (or at least there is negligible rise in temperature), it is possible to establish a reference resistance in the control circuit 200.

$${i}_{t} = \frac{V}{{R}_{s}} ( 1 - {e}^{- \frac{t}{τ}} ) , τ = \frac{{L}_{s}}{{R}_{s}}$$

Where iₜ=current at time t; V=voltage; Rₛ=series resistance; t=temperature; τ=time constant for the control circuit 200; Lₛ=series inductance. At a steady state the term

$$( 1 - {e}^{- \frac{t}{τ}} )$$

becomes 1 and using Ohms law:

$${i}_{∞} = \frac{V}{{R}_{s}} results in {R}_{s} = \frac{V}{{i}_{∞}}$$

The resistance calculated Rₛ is the Series Resistance. In other words, it gives an indication of the resistance including the Solenoid 120 DC Resistance (Sol. R), the sense resistor(s) 202 (Rₛₑₙₛₑ), and in this case MOSFETs (Mosfets Rds-on) (i.e. is R_{DC}+Rₛₑₙₛₑ+R_{DS}_{_{(ON)}} of MOSFETs). The sense resistor(s) 202 and the MOSFETs are small (i.e., around 0.45 (2) and don't change much with temperature compared to the solenoid. The following table gives any indication of the components in the example control circuit 200 using the references indicated above (Added. R is Rₛₑₙₛₑ and Mosfets Rds-on added together and indicates the predetermined constant component resistance):

| | | |
|---|---|---|
| Sol. R, Ω | 2.8 | DC resistance room Temp. |
| Rsense, Ω | 0.44 | x2-0.22 Ω |
| Mosfets Rds-on, Ω | 0.02 | x2-0.01 Ω (IRF1018) |
| Added. R, Ω | 0.46 | added resistance (const) |
| total. Rs, Ω | 3.3 | csircult ser. resistance |

To calculate the solenoid winding temperature (i.e. the windings of the actuator 120), the solenoid resistance Rₛₒₗ must be determined from the total circuit series resistance (i.e. the difference between the total circuit resistance measured and the constant component resistance):

$${R}_{sol} = {R}_{s} - {R}_{added}$$

In the example, outlined above this will be:

$${R}_{sol} = {R}_{s} - 0.46$$

This method can be progressed in order to provide a determination of the temperature of the actuator 120. In other words, the controller 150 is operable to determine the temperature within the actuator 120. This is discussed in more detail below.

In some embodiments, the controller 150 is operable to provide an alert and/or stop the printing apparatus 101 if the current temperature (i.e. the determined temperature within the actuator 120) is higher than a predetermined threshold.

In some embodiments, the controller 150 is operable to complete an initial calibration step to determine a solenoid factor. This calibration could be completed every time the printing apparatus 101 is powered to start printing, or it could be repeated at a predetermined interval (i.e. every 10 times the printing apparatus 101 is powered), or it could be performed only when a new actuator 120 is fitted—i.e. the first time the printing apparatus is powered and when components including the actuator 120 are replaced in a maintenance program.

In some embodiments, the calibration process completed by the controller 150 includes:
1) at a first temperature, determining a current in the control circuit, and
2) determining, based on the current, a resistance parameter relating to a resistance in the actuator at the first temperature and using the resistance parameter to calculate the solenoid factor; and
3) storing the solenoid factor.

For step 1), essentially the controller 150 is operable to perform the same actions as described above where the controller 150 determines the reference resistance of the control circuit 200. As discussed above, the sense resistor 202 is used to provide an indication of the instantaneous current within the control circuit 200.

In this example, the first temperature is the temperature in a housing or case of the actuator 120. This calibration step is completed when the temperature within the actuator 120 (i.e. inside the winding of the solenoid or motor) is the same or similar to that of the temperature outside of the actuator 120 (i.e. in the actuator 120 case). In other words, the first temperature may be an ambient temperature. What is important is that the step is completed when the actuator 120 has reached an equilibrium state with the outside environment. In other words, step one is performed at the start of operating the actuator 120 (or close to the start) when the current is stable but the actuator 120 has not had opportunity to rise in temperature from the ambient state.

In this example, the instantaneous current determined by the controller 150 is used to find the present resistance in the control circuit 200 (in a similar manner to that discussed above already).

It should be appreciated that the controller 150 could use the predetermined constant component resistance outlined above. The predetermined constant component resistance is the aggregate resistance arising from all the components in the control circuit 200 excluding the actuator 120. The controller 150 can then determine a difference between the resistance parameter and the predetermined constant component resistance to establish the resistance in the actuator 120.

As such the actuator 120 resistance can be determined from the control circuit 200 resistance. The actuator 120 resistance is a reference resistance—the solenoid factor-which is stored by the controller 150. More details of how the solenoid factor is determined are outlined below.

In some embodiments, the printing apparatus 101 may include a temperature sensor in the main body of the print apparatus 101. Alternatively or additionally, a temperature sensor could be provided in the actuator 120 housing.

As mentioned above, the temperature of the solenoid 120 windings is normally higher than the case temperature and this will depend on winding-to-case thermal resistance Rₜₕ_{_{WC}}. The windings resistance cannot be measured by standard means like a temperature sensor because it would need to be attached inside the device between the windings (which is not possible). However, the winding temperature can be calculated based on the coil resistance Rₛₒₗ, which is temperature dependent.

Thus, to calculate the solenoid or DC-motor 120 windings temperature, a Specific Coefficient of Resistance of the winding material is needed (i.e. the solenoid factor). Resistance values for conductors at any temperature other than the standard temperature (usually 20° C.) on the specific resistance table must be determined through the formula:

$$R ( T ) = R ( {T}_{0} ) ( 1 + α Δ T )$$

The “alpha” (a) constant is known as the temperature coefficient of resistance and symbolizes the resistance change factor per degree of temperature change. In other words, the resistance at a reference temperature T₀, is related to the resistance at any temperature through a coefficient factor and the difference in temperature. This is expressed further below:

$$R = {R}_{ref} [ 1 + α ( T - {T}_{ref} ) ]$$

Where,
R=Conductor resistance at temperature “T”
R_{ref}=Conductor resistance at reference temperature T_{ref}: usually 20° C., but sometimes 0° C.
α=Temperature coefficient of resistance for conductor material.
T=Conductor temperature in degrees Celcius.
T_{ref}=Reference temperature that α is specified at for the conductor material

The following table gives example temperature coefficients of resistance (a) for several common metals, both pure and alloy:

Temperature Coefficients of Resistance at 20 Degrees Celsius

| Material | Element/Alloy | “alpha” per degree Celsius |
|---|---|---|
| Nickel | Element | 0.005866 |
| Iron | Element | 0.005671 |
| Molybdenum | Element | 0.004579 |
| Tungsten | Element | 0.004403 |
| Aluminum | Element | 0.004308 |
| Copper | Element | 0.004041 |
| Silver | Element | 0.003819 |
| Platinum | Element | 0.003729 |
| Gold | Element | 0.003715 |
| Zinc | Element | 0.003847 |
| Steel* | Alloy | 0.003 |
| Nichrome | Alloy | 0.00017 |
| Nichrome V | Alloy | 0.00013 |
| Manganin | Alloy | +/−0.000015 |
| Constantan | Alloy | −0.000074 |

*= Steel alloy at 99.5 percent iron, 0.5 percent carbon tys

Example test results showing the relationship between the resistance (Sol. R_{DC}, Ω) and the temperature in the solenoid (Sol. T,° C.) are shown in the table below. Further, the equivalent scenarios were also calculated using the formulae provided above (Winding calculated T,° C.). It should be appreciated that the coil material is usually copper (although sometimes aluminum).

| Oven test | | (solenoid only - no Rsense and MOSFETs) | | | | |
|---|---|---|---|---|---|---|
| Measured | Sol. R_{DC}, Ω | 2.8 | 3.4 | 3.6 | 3.7 | 4.0 |

| | | | | |
|---|---|---|---|---|
| Sol. T, ° C. | 25 | 80 | 100 | 130 |

| | | | | | |
|---|---|---|---|---|---|
| Winding Calculated T, ° C. | 25 | 79 | 97 | 106 | 133 |
| err T, ° C. | 0 | 1 | 3 | −6 | −3 |

The table below illustrates how the solenoid resistance (solenoid R, Ω) changes with temperature (Solenoid T) and the current (current, A) if we keep constant PWM. Note the added 0.45Ω resistance from the control circuit 200 that does not arise from the actuator 120 (i.e. Rₛₑₙₛₑ+R_{DS}_{_{(ON)}} of MOSFETs):

PSU, V = 36 V PWM = 16.5% Vavg = 5.9

| | | | |
|---|---|---|---|
| Solenoid T, ° C. | 25 | 80 | 130 |
| solenoid R, Ω | 2.8 | 3.4 | 4.0 |
| added R, Ω | 0.45 | 0.45 | 0.45 |
| circuit Rs, Ω | 3.3 | 3.9 | 4.5 |
| current, A | 1.8 | 1.5 | 1.3 |

Using the above information, the controller 150 completes the calibration steps (i.e. steps 1 to 3) outlined above.

In some embodiments, the reference resistance (i.e. the solenoid factor) is determined from the present current within the control circuit 200. In short, R_{ref}, the conductor resistance is found at T_{ref}, the reference temperature, using a is specified at T_{ref}. As mentioned above, the coefficient could be at ambient temperature—i.e. around 20° C. but could be at 0° C. The coefficient will be known since the material of the actuator 120 windings will be known.

R_{ref} (i.e. the reference resistance that provides a “solenoid factor”) must be measured once. Through knowledge of the solenoid or DC-motor 120 coil material, usually copper and DC resistance Rₛ_{_{amb}} at room temperature when the printer starts working and it is in its equilibrium state and cold (i.e., when all internal parts have same temperature).

In some embodiments, the ambient temperature inside the printer 101 is measured via a temperature sensor and the coil resistance is measured in real-time by using Ohms Law when the solenoid or DC-motor current reaches steady state (but before substantial heating is experienced).

This provides the total series 200 resistance at ambient Rₛ_{_{amb}} The solenoid 120 coil resistance is determined: Kₛₒₗ_{_{amb}}=Rₛ_{_{amb}}-R_{added} (as already outlined above). Now, knowing the Rₛₒₗ_{_{amb}} (i.e. the resistance at a known first temperature) and T_{amb} (the first temperature), the R_{ref} (the solenoid factor) at a temperature when the printer starts working and it is stored in memory (e.g., the EEPROM):

$${R}_{{{ref}_{STORED}}_{}} = \frac{{R}_{{sol}_{amb}}}{1 + a ( {T}_{amb} - {T}_{ref} )}$$

It should be appreciated that this value is for this solenoid 120 fitted in the printer. If this solenoid 120 is replaced, this must be measured again and stored again in the memory.

Once the solenoid factor (i.e. the reference resistance for the actuator 120) is determined and stored the printing apparatus 101 is ready to operate normally.

In some embodiments, the controller 150 is operable to follow the following procedure during operation of the printing apparatus 101. This process is to establish the instantaneous/current temperature within the actuator 120. Thus, it can be used to provide an alert if the temperature exceeds a predetermined threshold.

In embodiments, the controller 150 is operable to:
1) determine a second current in the control circuit;
2) determine, based on the second current, a second resistance parameter relating to the resistance in the actuator, and
3) determining, using the second resistance parameter and the solenoid factor, the present temperature in the actuator.

For step 1), the second current is determined in the same manner as that already described—i.e. using the sense resistor 202.

For step 2), using the second/instantaneous current, another/a second resistance parameter is established. As discussed at length above, this is the instantaneous resistance of the control circuit 200 as a whole and not the actuator 120 resistance alone (i.e. the resistance parameter is related to the resistance in the actuator 120).

For step 3), the controller 150 is then operable to determine the present/instantaneous temperature in the actuator 120, using the second resistance parameter and the solenoid factor, the present temperature in the actuator.

In embodiments, the controller 150 is operable to obtain a predetermined constant component resistance which is an aggregate resistance arising from all the components in the control circuit 200 excluding the actuator 120. The controller 150 can then determine a difference between the resistance parameter and the predetermined constant component resistance to establish the resistance in the actuator 120. Thus, the resistance in the actuator 120 is used to calculate the present temperature in the actuator 120.

During the printing process, the temperature rises, and internal coil resistance will rise too. By measuring the solenoid or DC-motor 120 coil resistance continuously, it allows indirect measurement of the coil temperature (i.e. the temperature within the actuator 120), which is higher than the solenoid/DC-motor case temperature.

The formula outlined above can be rearranged to determine the temperature T of the solenoid or DC-motor windings/coil (i.e. within the actuator 120) in real time.

$${T}_{winding} = {T}_{ref} + \frac{\frac{{R}_{{sol}_{now}}}{{R}_{{ref}_{EEPROM}}} - 1}{a}$$

The symbols above and used in the above description are outlined in the list below:
α temperature coefficient of resistance for conductor material
T_{ref} ref. temperature that a is specified at for the conductor material (usually 20° C. but sometimes 0° C.)
R_{ref}_{_{STORED}} conductor resistance at ref. temperature T_{ref} (the solenoid factor)
T_{amb} ambient, starting temperature (only used in the calibration steps)
Rₛₒₗ_{_{amb}} sol. conductor resistance at ambient (starting) temperature T_{amb}
Rₛₒₗ_{_{now}} sol. conductor resistance measured continuously in real time
T_{winding} temperature now in° C. in the actuator 120 (i.e. when Rₛₒₗ_{_{now}} is measured); this is solenoid coil/winding temperature
R_{added} added resistance (Rₛₑₙₛₑ+R_{DS}_{_{(ON)}} MOSFETs)-assumed to be constant.

This way an error event can be generated (e.g., by the control software/firmware) if the temperature goes too high, to prevent damaging the coil insulation. This is especially important if operating at high ambient temperatures.

In other words, the controller 150 may be operable to provide an alert in the form of warning messages or sounds if the temperature within the actuator 120 exceeds one or more thresholds.

In some embodiments, the controller 150 is operable to control the actuator 120 differently if it detects that a printing operation is not required. In other words, if the controller 150 detects that the substrate 114 has stopped moving (i.e. there is no active printing phase occurring), it can alter the supply signal to the actuator 120. This may reduce a build-up in temperature within the actuator 120 (thus, the actuator 120 may have a longer life and maintenance may be reduced).

In embodiments the controller 150 is operable to decrease the supply signal or the updated supply signal to the actuator 120 if a pause in printing operations is detected. This decrease in supply signal results in a reduction of a pressure that is exerted by the print head 110. In other words, the print head 110 is reversed from its printing state (the combination of position and pressure that allows printing to occur) but does not retract the print head 110 to the ready position.

In embodiments, the pressure is reduced to a point at which the print head 110 remains in contact with the substrate 114 and/or inked tape 112 but no significant pressure is applied.

In embodiments, when the controller 150 detects a printing operation is about to start (i.e. the substrate 114 starts to move), it is operable to increase the supply signal to the actuator 120 such that the print head 110 returns to its printing state.

Further details are outlined below. In short, the solenoid or DC-motor 120 generates heat when creating pressure behind the print head 110. In other words, by holding the print head 110 at its printing state, heat will build-up in the actuator 120. This heat is difficult to dissipate, wastes energy and may cause the printer 101 to fail due to over-temperature.

There are occasions when the thermal transfer printer 101/the controller 150 will see the substrate 114 stationary for a length of time. This time could be seconds or even hours. However, it should be appreciated that the substrate 114 could move suddenly and without any notice. The thermal transfer printer 101/controller 150 needs to be ready to print as soon as substrate 114 motion is detected. Hence, the print head 110 needs to be in the printing position especially if it is stopped while printing an image.

However, if the print head 110 is left in its printing state with recommended/set pressure required for printing (i.e. the print head 110 is left in the printing state), the actuator's 120 (DC-motor or solenoid's) heat will continue to rise.

In embodiments, to slow down the rise in temperature, the pressure on the print head 110 can be decreased to a point where the print head 110 maintains the contact between the ribbon 112 and the substrate 114. The supply signal provides just enough power to keep in this state—i.e. the print head 110 in the printing position but with pressure approaching 0 N/m². This is well below the power to generate printing mode pressure (i.e. the printing state).

In short, this reduces the energy applied to the solenoid or DC-motor (actuator 120) and therefore reduces the heat generated (and the resulting temperature rise within the actuator 120). When the substrate 114 starts moving again, the printing pressure is reapplied, but the print head 110 doesn't need to move back to the print position. This saves time and reduces gaps in the currently printed image.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A printing apparatus, for transfer printing in which a print head is moved towards and away from an inked tape and a substrate, including:
a print head, and a print head actuation assembly, and
a controller which is configured to control the print head actuation assembly to move the print head between a first rest position, a second ready position and a third printing position, wherein
the print head actuation assembly includes:
a first solenoid which is connected to the print head to actuate movement of the print head between the first rest position and the second ready position, and
a second solenoid which is connected to the print head to actuate movement of the print head between the second ready position and the third printing position.

2. A printing apparatus according to claim 1 wherein the first solenoid is bistable, and optionally wherein when the first solenoid is in a first state, the print head is positioned in the first rest position, and when the first solenoid is in a second state, the print head is positioned in the second ready position.

3. (canceled)

4. A printing apparatus according to claim 2 wherein the controller is configured to supply a signal to actuate the first solenoid between its first and second states, and wherein when the signal is removed the first solenoid remains in the one of the first and second states that it was in when the supply was removed, and optionally wherein the first solenoid is a latching solenoid.

5. (canceled)

6. A printing apparatus according to claim 1 wherein the print head actuation assembly includes a third solenoid, which operates in cooperation with the first solenoid, and optionally wherein the first and third solenoid have matching first and second states.

7. (canceled)

8. A printing apparatus according to claim 1 wherein the second solenoid moves the print head between the second ready position and the third printing position using angular rotation, and optionally wherein the second solenoid is a rotary solenoid.

9. (canceled)

10. A printing apparatus according to claim 8 wherein the second solenoid is configured to rotate ±60 degrees, ±45 degrees, ±30 degrees or ±22.5 degrees.

11. A printing apparatus according to claim 1 wherein the second solenoid includes an arm, which is connected directly to the print head, and/or wherein the print head and print head actuation assembly are provided on a carriage assembly which is moveably mounted such that when the first solenoid is actuated the carriage assembly is moved, and/or wherein the distance between the first rest position and the second ready position is around 7 mm, and/or the distance between the second ready position and the third printing position is around 4 mm.

12. (canceled)

13. (canceled)

14. A printing apparatus, for transfer printing in which a print head is moved towards and away from an inked tape and a substrate, including
a print head, and an actuator, and
a controller which is configured to control the movement of the print head via the actuator through a control circuit, the controller is configured to:
apply a first supply signal to the actuator, so that the print head is moved to a printing state,
determine a current within the control circuit,
determine, based on the current, a resistance parameter related to a resistance within the actuator,
determine, using the resistance parameter, an updated supply signal for maintaining the print head in the printing state, and
apply the updated supply signal to the actuator.

15. A printing apparatus according to claim 14 wherein the controller is configured to set the first supply signal based on a target current which moves the print head to the printing state, and optionally wherein the controller is configured to determine the updated supply signal using the target current and the resistance parameter.

16. (canceled)

17. A printing apparatus according to claim 14 wherein the controller is configured to, when determining the updated supply signal:
obtain, from a memory, a predetermined constant component resistance which is an aggregate resistance arising from all the components in the control circuit excluding the actuator,
determine a difference between the resistance parameter and the predetermined constant component resistance to establish the resistance in the actuator, and
calculate the updated supply signal using the resistance in the actuator and the target current.

18. A printing apparatus according to claim 14 to wherein the printing state includes a predetermined print head position and a predetermined pressure that the print head exerts on an inked tape and/or substrate in a printing operation.

19. A printing apparatus according to claim 14 wherein the controller is further operable configured to:
determine, based on a second current, an updated resistance parameter,
determine, using the updated resistance parameter, a further updated supply signal for maintaining the print head in the printing state, and
apply the further updated supply signal to the actuator.

20. A printing apparatus according to claim 14 wherein the control circuit includes a sense resistor, and/or wherein the updated supply signal and/or the further updated supply signal is higher than the first supply signal.

21. (canceled)

22. A printing apparatus according to claim 14 wherein the controller is operable configured to:
calculate a current temperature in the actuator based on the resistance parameter, and optionally wherein the controller is configured to provide an alert and/or stop the printing apparatus if the current temperature is higher than a predetermined threshold.

23. (canceled)

24. A printing apparatus according to claim 14 wherein the controller is configured to:
decrease the supply signal or the updated supply signal to the actuator if a pause in printing operations is detected, so that a pressure that is exerted by the print head in the printing state is reduced, and optionally wherein the pressure is reduced to a point at which the print head remains in contact with the substrate and/or inked tape but no significant pressure is applied.

25. (canceled)

26. A printing apparatus according to claim 14 wherein the controller is configured to:
increase the supply signal to the actuator when a printing operation is detected.

27. A printing apparatus, for transfer printing in which a print head is moved towards and away from an inked tape and a substrate, including:
a print head, and an actuator, and
a controller which is configured to control the movement of the print head via the actuator through a control circuit, the controller being configured to, during an initial calibration step to determine a solenoid factor:
at a first temperature, determine a current in the control circuit, and determine, based on the current, a resistance parameter relating to a resistance in the actuator at the first temperature and use the resistance parameter to calculate the solenoid factor; and
store the solenoid factor;
wherein during operation of the printing apparatus the controller is configured to determine a present temperature in the actuator by being configured to:
determine a second current in the control circuit;
determine, based on the second current, a second resistance parameter relating to the resistance in the actuator, and
determine, using the second resistance parameter and the solenoid factor, the present temperature in the actuator.

28. A printing apparatus according to claim 27 further including a temperature sensor which measures the first temperature, and/or wherein the control circuit includes a sense resistor.

29. (canceled)

30. A printing apparatus according to claim 27 wherein the resistance parameter is used by performing operations comprising:
obtaining, from a memory, a predetermined constant component resistance which is an aggregate resistance arising from all the components in the control circuit excluding the actuator, and
determining a difference between the resistance parameter and the predetermined constant component resistance to establish the resistance in the actuator and using the resistance in the actuator to calculate the solenoid factor and/or the present temperature in the actuator.

31. A printing apparatus according to claim 27 wherein the controller is configured to:
apply a first supply signal to the actuator, so that the print head is moved to a printing state,
determine a current within the control circuit,
determine, based on the current, a resistance parameter related to a resistance within the actuator,
determine, using the resistance parameter, an updated supply signal for maintaining the print head in the printing state, and
apply the updated supply signal to the actuator.
